(19) United States
(12) Patent Application Publication
(10) Pub. No.: US 2023/0400841 A1
(43) Pub. Date: Dec. 14, 2023

(54) System of Matching Segmented Words to Check Correctness of Components of Device and Method Thereof

(71) Applicants: Inventec (Pudong) Technology Corporation, Shanghai (CN); Inventec Corporation, Taipei City (TW)

(72) Inventor: Shu-Qing Chen, Shanghai (CN)

(21) Appl. No.: 17/848,160

(22) Filed: Jun. 23, 2022

(30) Foreign Application Priority Data
Jun. 14, 2022 (CN) 202210669314.5

(51) Int. Cl. G05B 19/418

(52) U.S. Cl. CPC G05B 19/41875; G05B 2219/32368

(57) ABSTRACT

A system of matching segmented words to check correctness of components of a device and a method thereof are disclosed. String processing and string segmenting is performed on one of component messages of a target device and one of pieces of material data in bill of materials of the target device, to generate component key words and material key words, and the component key words and the material key words are compared with each other, and when a quantity of the matching pairs of the component key words and the material key words reaches a quantity threshold, the component message is determined to match a bill of materials. When all component messages match the bill of materials, a check for the target device is passed.

### CROSS-REFERENCE TO RELATED APPLICATION

This application claims the benefit of Chinese Application Serial No. 202210669314.5, filed Jun. 14, 2022, which is hereby incorporated herein by reference in its entirety.

### BACKGROUND OF THE INVENTION

### 1. Field of the Invention

The present invention relates to a device checking system and a method thereof, and more particularly to a system of matching segmented words to check correctness of components of a device and a method thereof.

### 2. Description of the Related Art

Industry 4.0 (also known as the fourth industrial revolution) is not just creation of new industrial technologies, but focuses on the integration of existing industrial technologies, sales processes and product experience, so as to build a smart factory with adaptability, resource efficiency and ergonomics through artificial intelligence (AI) technology, and integrate customers and business partners in the business process and value process to provide perfect after-sales service, thereby establishing a new intelligent industrial world with perception consciousness.

With the wave of the Industry 4.0 sweeping the world, manufacturers are all using smart manufacturing to optimize production transformation and enhance competitiveness. The smart manufacturing is to realize the intelligent product design and manufacturing, and enterprise management and service based on sensing technology, network technology, automation technology and AI through the processes of perception, human-computer interaction, decision-making, execution and feedback.

The electronic assembly industry has characteristics of small profits but quick turnover and fierce product price competition, so the manufacturers in the electronic assembly industry always pursue more effective control and optimization of raw materials and production tools, thereby maximizing the efficiency of factory production resources. For example, the production line of the electronic assembly industry includes many test stages for various circuit boards; the production line includes the test stage for checking whether the components installed in the completed device match expectations, so as to prevent delivering the device with the wrong assembly from the factory.

The conventional method of checking whether the components in the device match expectations is to execute a specific program installed on the device that has been confirmed to be ready for delivery in advance, to detect component messages of the components installed or set in the device; next, a comparison list is created based on the detected component messages, so that the completed device is compared with the pre-generated comparison list during the production process. The above-mentioned conventional method is to compare the pre-generated list with the component messages of the components actually installed or set in the device; however, when the completed device is installed or set alternative materials due to the expected materials are short, the above-mentioned conventional method will issue a problem of inconsistency in the comparison, and it causes trouble in a production process.

In order to solve the above-mentioned problems, some solutions using databases are developed, for example, a material substitution table of expected materials and alternative materials are created in advance, the pre-created comparison list is compared with the component messages of components actually-installed or set in the device, when the expected material in the comparison list does not match the actual component in the device, the actual component is then compared with the alternative material of the expected material recorded in the material substitution table. However, the above-mentioned solution needs to frequently add and modify alternative materials of expected materials and still requires additional manpower to maintain the material substitution table.

According to above-mentioned contents, what is needed is to develop an improved solution to solve the convention problem of extra manpower and time cost to check the correctness of the components in a device.

### SUMMARY OF THE INVENTION

An objective of the present invention is to provide a system of matching segmented words to check correctness of components of a device and a method thereof, so as to solve the conventional technology problem that extra manpower and time cost is required to check the correctness of the components in a device.

In order to achieve the objective, the present invention provides a system of matching segmented words to check components of a device, and the system includes a message obtaining module, a bill obtaining module, a word processing module, a word comparing module, and a result determining module. The message obtaining module is configured to obtain a component list of components of a target device, wherein the component list includes component messages. The bill obtaining module is configured to obtain a bill of materials of the target device, wherein the bill of materials records pieces of material data. The word processing module is configured to perform string processing and segmenting on one of the component messages and corresponding material data to generate component key words and the material key words corresponding to the one of the component messages. The word comparing module is configured to compare the component key words and the material key words corresponding to the one of the component message, wherein when a quantity of matched component key words and material key words corresponding to the one of the component messages reaches a quantity threshold, the word comparing module determines that the one of the component messages matches the bill of materials. The result determining module is configured to determine that a check for the target device is passed when all of the component messages match the bill of materials.

In order to achieve the objective, the present invention provides a method of matching segmented words to check components of a device, and the method includes steps of: obtaining a component list of components of a target device, wherein the component list comprises component messages; obtaining a bill of materials of the target device, wherein the bill of materials records pieces of material data; performing string processing and segmenting on one of the component messages and a corresponding one of the pieces of material data, to generate component key words and the material key words corresponding to the one of the component messages; comparing the generated component key words and the material key words corresponding to the one of the component messages, and determine that the one of the component messages matches the bill of materials when a quantity of the generated component key words and the material key words corresponding to the one of the component messages and matched each other reaches a quantity threshold; determining that a check for the target device is passed when all of the component messages match the bill of materials.

According to the above-mentioned system and method of the present invention, the difference between the present invention and the conventional technology is that, in the present invention, the string processing and the string segmenting are performed on each of component messages of the target device and the corresponding one of pieces of material data, to generate the component key words and the material key words corresponding to the component message performed the string processing and the string segmenting, and the component key words corresponding to one of the component messages are compared with the material key words corresponding to the same component message, and when the quantity of the matching pairs of the component key words and the material key words corresponding to the same component message reaches the quantity threshold, the component message performed the string processing and the string segmenting is determined to match the bill of materials. When all of the component messages match the bill of materials, the check for the target device is passed. Therefore, the conventional problem can be solved and the technical effect of effectively improving accuracy of checking the components of the device can be achieved.

### BRIEF DESCRIPTION OF THE DRAWINGS

The structure, operating principle and effects of the present invention will be described in detail by way of various embodiments which are illustrated in the accompanying drawings.

FIG. 1 is a structural view of a system of matching segmented words to check correctness of components of a device, according to the present invention.

FIG. 2A is a flowchart of a method of matching segmented words to check correctness of components in a device, according to the present invention.

FIG. 2B is a flowchart of a method of determining whether a quantity of components is correct, according to the present invention.

FIG. 2C is a flowchart of an additional method of matching segmented words to check correctness of components in a device, according to the present invention.

FIG. 2D is a flowchart of a method of determining correctness of components based on weights, according to the present invention.

FIG. 3 is a schematic view showing string processing and string segmenting are performed on a component message and a corresponding material data, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

The system and method of the present invention is to check whether the components in target device match the content recorded in a bill of materials (BOM). Generally speaking, the checking process of the present invention is performed on a target device before delivery or before software/hardware/firmware testing, but the present invention is not limited thereto.

The target device mentioned in the present invention is usually a computing device such as a server or a computer, but the present invention is not limited thereto. The components mentioned in the present invention can be parts installed or set in the target device; in some embodiments, the component can also be firmware or software installed in the target device.

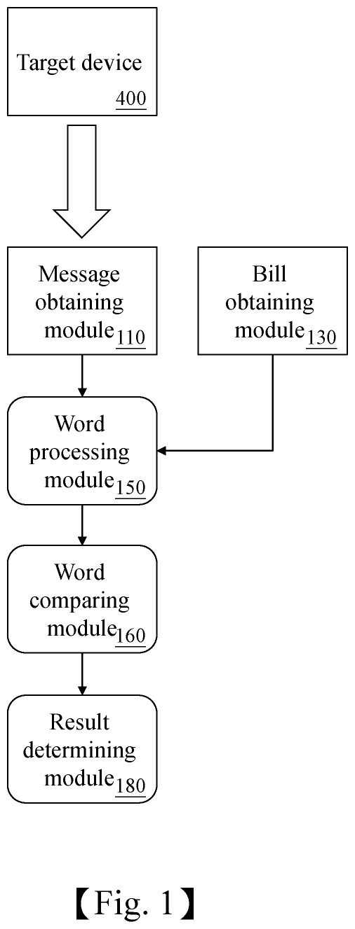

The operation of the system of the present invention will be illustrated in the following paragraph with reference to FIG. 1. As shown in FIG. 1, the system includes a message obtaining module 110, a bill obtaining module 130, a word processing module 150, a word comparing module 160 and a result determining module 180. The system of the present invention can be applied in a computing apparatus.

The message obtaining module 110 is configured to obtain a component list of components installed or set in a target device 400, and the component list obtained by the message obtaining module 110 includes one or more component messages; in an embodiment, each component message records a component name, a component type, a manufacturer, a component model, a component specification, one (or more) component parameter(s), and a quantity of each of the components installed or set in the target device 400, but the present invention is not limited the above-mentioned examples. The component type includes but not limited to processor, memory, hard disk drive, motherboard, graphics card, network card, fan, power supplies, etc.

The message obtaining module 110 is connected to the target device 400, by wired or wireless communication manner, and configured to download the component list generated by the target device 400. The message obtaining module 110 can read the component list uploaded by the target device 400 to the computer apparatus implementing the present invention, or can be connected to a storage device (not shown in figures) by wired or wireless communication manner to download the component list that is transmitted and stored to the storage device by the target device 400. In an embodiment, the message obtaining module 110 generates and transmits the control message to the target device 400, the target device 400 drives the specific hardware or firmware installed in the target device 400 based on the received control message, or execute the specific software pre-installed in the target device 400, so as to generate and store the component list, or transmit the generated component list to the computer apparatus implementing the present invention or the storage device.

The bill obtaining module 130 is configured to obtain the bill of materials of the target device 400. The bill of materials obtained by the bill obtaining module 130 records pieces of material data; In an embodiment, each of the pieces of material data includes one or more material messages, each material message records a material name, a material type, a manufacturer, a material model, a material specification, one (or more) material parameter(s), and quantity of the material installed or set in the target device 400, but the present invention is not limited thereto. The material type includes but not limited to processor, memory, hard disk drive, motherboard, graphics card, network card, fan, power supplies, etc.

The bill obtaining module 130 reads the bill of materials of the target device 400 from a prebuilt database or a prebuilt file based on bill identification data representing the target device 400. The above-mentioned bill identification data can be preset data, or data inputted by the bill obtaining module 130, or the bill obtaining module 130 obtains the data when being connected to the target device 400 by wired or wireless communication manner. The bill identification data can be device identification data of the target device 400, or component identification data of specific hardware installed in the target device 400. The device identification data is such as a serial number or a network address of the target device 400, and the component identification data is such as a serial number of a processor, serial number of a chip, MAC address, but the present invention is not limited to the above-mentioned examples.

The word processing module 150 performs a string processing and a string segmenting on the component message obtained by the message obtaining module 110 and the material data obtained by the bill obtaining module 130, to generate component key words and material key words corresponding to the component message. In detail, from the component messages obtained by the message obtaining module 110, the word processing module 150 one by one selects a component message that is not selected yet, selects every material messages from the pieces of material data obtained by the bill obtaining module 130, and performs the string processing and the string segmenting on the selected component message and the selected material message; the above-mentioned operations are continuously repeated until all component messages and all material messages are selected. The string processing performed by the word processing module 150 can be at least one of case conversion, specific character (such as blank character, space character “•”, connecting character “−”, etc.) removal, specific word (such as the words indicating or describing components/materials, etc.) removal, replacement proper noun (such as company name or unit of quantity, etc.) with abbreviation, replacement word with synonyms having same meaning, and converted numerical quantity unit performed on the selected component message and the selected material message. The string segmenting can be performed by the word processing module 150 based on a specific word or specific character or combination of characters, such as commas, semicolons, or predefined character set, etc.

The word comparing module 160 is configured to compare the component key words and the material key words generated by the word processing module 150 and corresponding to the component message obtained by the message obtaining module 110, so as to determine whether the component key words and the material key words corresponding to the same component message match each other. It should be noted that, if the component type of the component message is the same as the material type in the material message, the component key words generated by the word processing module 150 according to the component message and the material key words generated by the word processing module 150 according to the material message are corresponding to the same component message. But the present invention is not limit thereto. The word comparing module 160 can also define each material key word one by one as corresponding to each component message for determining whether the material key words match the component key words.

In an embodiment, the word comparing module 160 selects a comparison manner for comparing the component key words and the material key words corresponding to the same component message, based on a data type or both of the data type and a sting length of the component key word. The above-mentioned data type can be, for example, text, number (may contain unit of quantity), date or time, but the present invention is not limited to these examples. The above-mentioned string length can be amount of characters of the component key word and the material key word.

The comparison manner used by the word comparing module 160 will be described in the following paragraphs. For example, when the data type of the component key word is number or date/time, the word comparing module 160 determines whether the component key word and the material key word are the same fully; when the data type of the component key word is text and the string length of the component key word is lower than a character count threshold, the word comparing module 160 determines whether a edit distance between the component key word and the material key word is lower than a distance threshold, or determines whether the material key words contain the component key word, or determines whether the component key words contain the material key word; when the data type of the component key words is text and the string length of the component key word is greater than or equal to the character count threshold, the word comparing module 160 determines, based on a long short term memory (LSTM) model, whether the component key word matches the corresponding material key word; for example, the word comparing module 160 determines whether the data outputted from the LSTM model, which receives the component key word, is the same as the material key word corresponding to the component key word; however, the present invention is not limited to above-mentioned examples.

When a quantity of the matching pairs of the component key words and the material key words corresponding to the same component message reaches a predetermined quantity threshold, the word comparing module 160 determines that the component message matches the bill of materials obtained by the bill obtaining module 130.

In an embodiment, the word comparing module 160 can define weights of the component key words generated by the word processing module 150, and when a sum of the weights of the component key words matching the material key words reaches a preset weight count threshold, or the sum of the weights of the matched component key words reaches the weight count threshold, and the quantity of the matching pairs of the component key words and the material key words reaches the quantity threshold, the word comparing module 160 determines that the component message corresponding to the matching pair of the component key words and the material key words matches the bill of materials obtained by the bill obtaining module 130.

When all of the component messages obtained by the message obtaining module 110 match the bill of materials obtained by the bill obtaining module 130, the result determining module 180 determines that a check for the target device 400 is passed; otherwise, the result determining module 180 determines that the check for the target device 400 is not passed.

In an embodiment, the result determining module 180 can determine whether a quantity of the component messages obtained by the message obtaining module 110 is the same as a quantity of the pieces of the material data obtained by the bill obtaining module 130, and when the quantity of the component messages obtained by the message obtaining module 110 is not the same as the quantity of the pieces of the material data obtained by the bill obtaining module 130, the result determining module 180 determines that the check for the target device 400 is not passed. In an embodiment, the result determining module 180 can determine whether the quantity value recorded in the component message is the same as the quantity value recorded in the material data corresponding to the same component message; when the quantity value recorded in the component message is not the same as the quantity value recorded in the material data corresponding to the same component message, the result determining module 180 also determines that the check for the target device 400 is not passed.

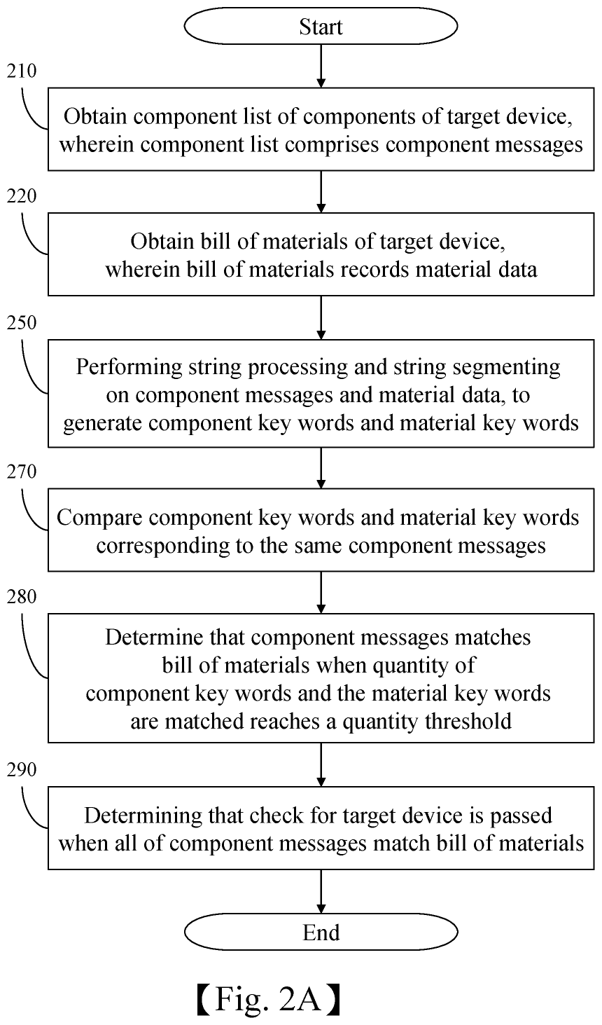

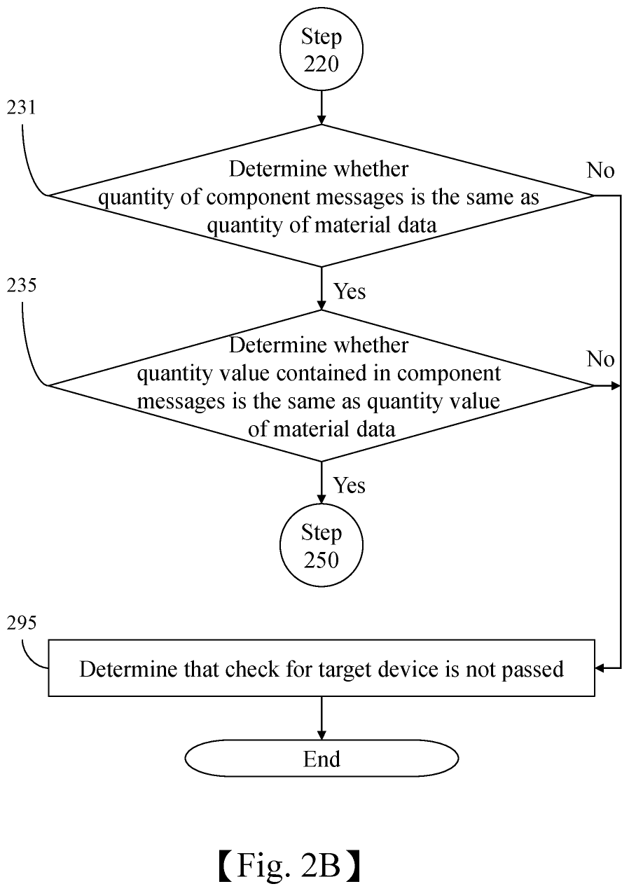

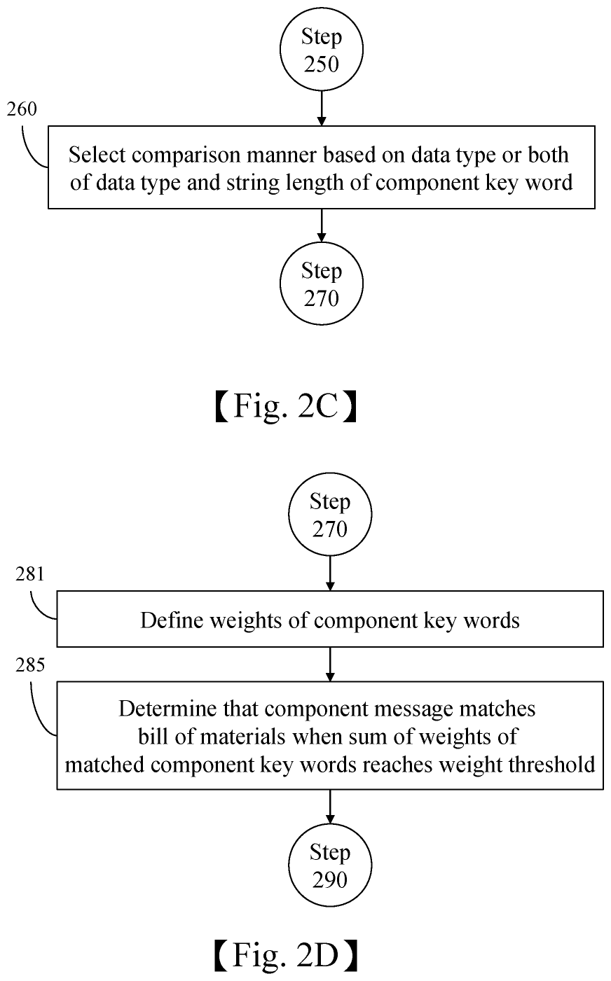

The operations of the system and the method of the present invention will be described with reference to an embodiment, and please refer to FIG. 2A. In this embodiment, the method of the present invention is applied to the environment where the target device 400 is produced, and the target device 400 is a server, but the present invention is not limited thereto.

After the target device 400 is assembled completely and before the target device 400 is delivered, or before the completely-assembled target device 400 is tested, the solution of the present invention can be executed to check whether the components installed or set in the target device 400 are correct.

In step 210, the message obtaining module 110 obtains a component list of components of the target device 400. In this embodiment, the message obtaining module 110 can transmit a control message to the target device 400, so that the target device 400 can generate the component list having the component messages and transmit the component list to the message obtaining module 110 based on the control message.

In step 220, after the present invention starts to execute, the bill obtaining module 130 obtains a bill of materials of the target device 400. In this embodiment, the bill obtaining module 130 can provide an input interface to test personnel for inputting the device identification data of the target device 400, or the target device 400 can transmits the device identification data to the bill obtaining module 130 after receiving the control message transmitted from the message obtaining module 110. Then, the bill obtaining module 130 reads the bill of materials of the target device 400 from a prebuilt database based on the device identification data inputted by the test personnel or the device identification data transmitted from the target device 400.

It is to be noted that there is no order relationship between the message obtaining module 110 and the bill obtaining module 130, except that the bill obtaining module 130 obtains the bill of materials of the target device 400 based on the device identification data transmitted from the target device 400 after the target device 400 receives the control message from the message obtaining module 110; in other words, the message obtaining module 110 can obtain the component list (step 210) after the bill obtaining module 130 obtains the bill of materials (step 220).

In step 250, after the message obtaining module 110 obtains the component list and the bill obtaining module 130 obtains the bill of materials, the word processing module 150 performs a string processing and a string segmenting on the component messages contained in the component list and the material message contained in the bill of materials, so as to generate component key words and material key words after the string processing and the string segmenting. In step 270, the word comparing module 160 defines one of the component messages is corresponded to the material key words generated from the same material message and compares the component key words and the material key words that correspond to the same component message, to determine whether the component key words and the material key words corresponding to the same component message match each other. In step 280, when a quantity of matching pairs of the component key words and the material key words corresponding to the same component message reaches a quantity threshold, it is determined that the component message corresponding to the matching pair of the component key words and the material key words matches the bill of materials.

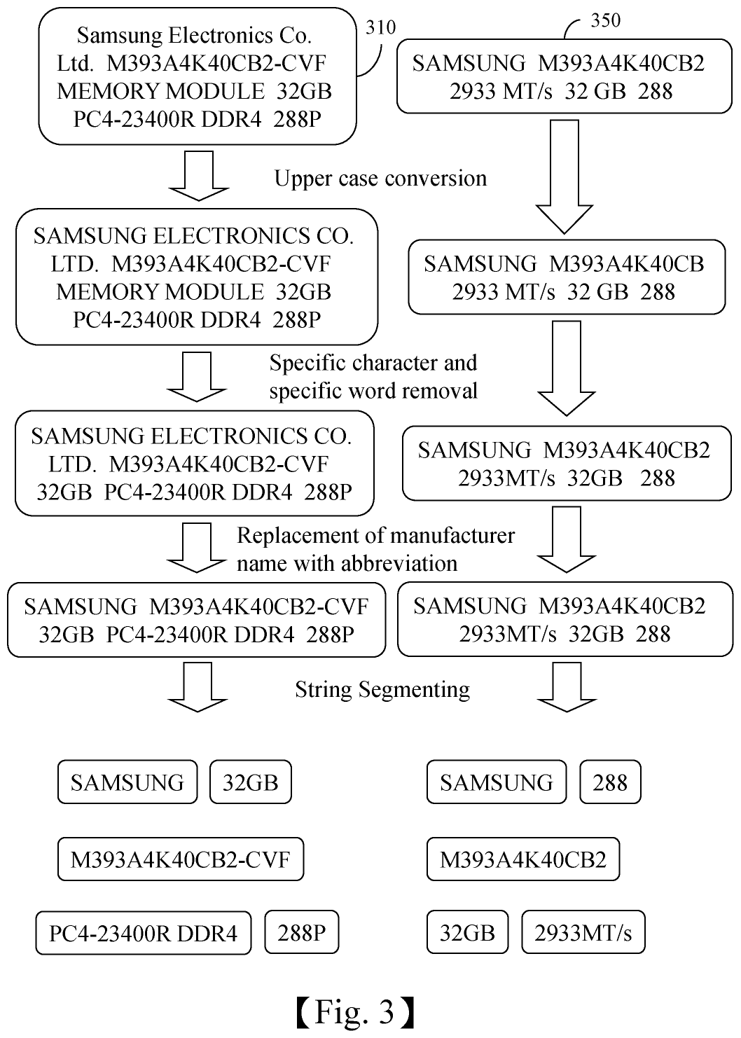

In this embodiment, the word processing module 150 one by one selects a component message, which is not selected yet from the component list, such as “Samsung Electronics Co. Ltd. M393A4K40CB2-CVF MEMORY MODULE 32 GB PC4-23400R DDR4 288P” (“Samsung Electronics Co. Ltd.” is manufacturer, “M393A4K40CB2-CVF” is component model, “MEMORY MODULE” is component type, “32 GB”, “PC4-23400R DDR4” and “288P” are component specification) and extracts each of the material messages, corresponding to the selected component message from the bill of materials (such as material type included in the material messages is “MEMORY MODULE” or “MEMORY”) or all of the material messages from the bill of materials, if one of the extracted material message is “SAMSUNG M393A4K40CB2 2933MT/s 32 GB 288”, as shown in FIG. 3, the word processing module 150 performs the string processing and the string segmenting on the selected component message 310 and the extracted material message 350, to generate the component key words and the material key words corresponding to the selected component message; for example, the word processing module 150 first converts the selected component message 310 and the extracted material message 350 into upper-case words, deletes component type (specific word and characters), such as “MEMORY MODULE”, from the selected component message 310, deletes blank character between numerical and quantitative unit from the extracted material message 350, replaces the manufacturer name “SAMSUNG ELECTRONICS CO. LTD.” by an abbreviated name “SAMSUNG” in the selected component message, and segments the selected component message and extracted material message after the above string processing according to a character set composed of two blank characters to generate component key words, such as “SAMSUNG”, “M393A4K40CB2-CVF”, “32 GB”, “PC4-23400R DDR4”, “288P”, and material key words, such as “SAMSUNG”, “M393A4K40CB2”, “2933MT/s”, “32 GB” and “288”, and performs unit conversion on “PC4-23400R DDR4” to generate the component key word “2933MT/s”. Next, the word comparing module 160 continuously compares whether the component key words match the material key words generated by the word processing module 150, for example, the word comparing module 160 compares the component key word “SAMSUNG” with the material key word “SAMSUNG”, “M393A4K40CB2”, “2933MT/s”, “32 GB” and “288”, compares the component key word “M393A4K40CB2-CVF” with the material key words “SAMSUNG”, “M393A4K40CB2”, “2933MT/s”, “32 GB” and “288”, compares the component key word “32 GB” with the material key words “SAMSUNG”, “M393A4K40CB2”, “2933MT/s”, “32 GB” and “288”, compares the component key word “2933MT/s” generated from the conversion of the component key word “PC4-23400R DDR4” with the material key words “SAMSUNG”, “M393A4K40CB2”, “2933MT/s”, “32 GB” and “288”, and compares the component key word “228P” with the material key words “SAMSUNG”, “M393A4K40CB2”, “2933MT/s”, “32 GB” and “288”. When the word comparing module 160 compares the component key words with the material key words, the word comparing module 160 first determines whether the component key words include the material key word, or determines whether the material key words include the component key word, if not, the word comparing module 160 use the edit distance algorithm to determine whether an edit distance between the component key word and the material key word is lower than or equal to 1; in other words, the word comparing module 160 determines that the component key word “SAMSUNG” and the material key word “SAMSUNG” are the same, that is, the component key word contains the material key word or the material key word contains the component key word; the component key word “M393A4K40CB2-CVF” contains the material key word “M393A4K40CB2”, the new component key word “2933MT/s” generated by conversion of the component key word “PC4-23400R DDR4” is the same as the material key word “2933MT/s”, the component key word “32 GB” and the material key word “32 GB” are the same, the component key word “288P” contains the material key word “288”, so the word comparing module 160 determines that the component key words “SAMSUNG”, “M393A4K40CB2-CVF”, “PC4-23400R DDR4”, “32 GB” and “288P” match the material key words “SAMSUNG”, “M393A4K40CB2”, “2933MT/s”, “32 GB” and “288”, respectively. In a condition that the quantity threshold is set as 3, the quantity of matching pairs of the component key words and the material key words corresponding to the selected component message is 5 that reaches the quantity threshold and completes the pairing of the selected component message, the word comparing module 160 determines that the selected component message matches the bill of materials, and finishes comparing the selected component message and other material message in the bill of materials. However, if the quantity of matching pairs of the component key words and the material key words corresponding to the selected component message does not reach the quantity threshold, the word comparing module 160 may continue to compare the component message generated from the selected component message with material key words generated from the other material message in the bill of the materials and determine whether the quantity of matching pairs of the component key words and the material key words corresponding to the selected component message reaches the quantity threshold for determining whether the selected component message is matched, until the selected component message is matched or all of optional material message is selected. Next, the word processing module 150 re-selects another component message that is not selected yet from the component list, defines and extracts one of the material message corresponded to the new selected component message, and generates the component key words and the material key words corresponding to the new selected component message (if the new extracted material message is extracted before, there is no need to perform string processing and string segments on the new extracted material message again). The word comparing module 160 checks whether the quantity of matching pairs of the new generated component key words and the material key words corresponding to the new selected component message reaches the quantity threshold, so as to determine whether the new selected component message matches the bill of materials. The above-mentioned operations are repeated until all of the component message of the component list are selected already.

After the word comparing module 160 determines whether the component messages of the component list obtained by the message obtaining module 110 match the bill of materials obtained by the bill obtaining module 130 (step 280) and all of the component messages match the bill of materials, the result determining module 180 determines that a check for the target device 400 is passed; otherwise, when at least one of the component messages of the component list does not match the bill of materials, the result determining module 180 determines that the check for the target device 400 is not passed.

As a result, the present invention is able to check whether the components installed and set in the target device 400 match the contents of the bill of materials, even when one of the component is different from the bill of materials.

In the above-mentioned embodiment, as shown in the flow of FIG. 2B, after the message obtaining module 110 obtains the component list (step 210) and the bill obtaining module 130 obtains the bill of materials (step 220), the result determining module 180 can determine whether the quantity of the component messages of the component list is the same as the quantity of the material messages of the bill of materials in step 231; if the quantity of the component messages of the component list is not the same as the quantity of the material messages of the bill of materials, the result determining module 180 directly determines that the check for the target device 400 is not passed, in step 295. When the result determining module 180 determines that the quantity of the component messages is the same as the quantity of the material messages, the word processing module 150 one by one select the component message that is not selected yet from the component list, to generate the component key words and the material key words corresponding to the new selected component message, the word comparing module 160 compares whether the quantity of the matching pairs of the new generated component key words and the material key words reaches the quantity threshold, so as to determine whether the new selected component message matches the bill of materials (steps 250 to 280). Similarly, in step 235, the result determining module 180 can determine whether the quantity value recorded in each component message of the component list is the same as the quantity value recorded in the material message of the bill of materials; when the quantity value recorded in the component message is the same as the quantity value recorded in the corresponding material message, the word processing module 150 and the word comparing module 160 perform the steps 250 to 280; when the quantity value recorded in at least one component message is different from the quantity value recorded in the corresponding material message, the result determining module 180 directly determines that the check for the target device 400 is not passed (step 295).

In the above-mentioned embodiment, as shown in the flow of FIG. 2C, after the word processing module 150 performs the string processing and segmenting on the component message contained in the component list and the material message of the bill of materials corresponding to the component message, to generate the component key words and the material key words corresponding to the component message (step 250), the word comparing module 160 first selects a comparison manner based on the data type or both of the data type and the string length of the component key word generated by the word processing module 150 in step 260, and compares the component key words and the material key words corresponding to the same component message based on the selected comparison manner, so as to determine whether the component key words and the material key words corresponding to the same component message match each other, in step 270. For example, the word comparing module 160 directly compares whether the component key word after unit conversion is the same as the corresponding material key word; or use the string distance algorithm (such as the edit distance algorithm) to compare whether the component key word that fails for unit conversion is the same as the corresponding material key word.

In the above-mentioned embodiment, as shown in the flow of FIG. 2D, after the word comparing module 160 compares the component key words and the material key words, which corresponding to the same component message and generated by the word processing module 150, to determine whether the component key words and the material key words corresponding to the same component message are matched each other (step 270), weights of the component key words can be defined in step 281, and a sum of the weights of the component key words matched the material key words is calculated; when the sum of the weights reaches a weight threshold, the word comparing module 160 determines that the component message corresponding to the matched component key words match the bill of materials obtained by the bill obtaining module 130 (step 285).

According to above-mentioned contents, the difference between the present invention and the conventional technology is that, in the present invention, the string processing and the string segmenting are performed on each of component messages of the target device and the corresponding one of pieces of material data, to generate the component key words and the material key words corresponding to the component message performed the string processing and the string segmenting, and the component key words corresponding to one of the component messages are compared with the material key words corresponding to the same component message, and when the quantity of the matching pairs of the component key words and the material key words corresponding to the same component message reaches the quantity threshold, the component message performed the string processing and the string segmenting is determined to match the bill of materials. When all of the component messages match the bill of materials, the check for the target device is passed. Therefore, the above-mentioned technical solution of the present invention is able to solve the conventional problem of extra manpower and time cost to check the correctness of the components of a device, to achieve the technical effect of effectively improving accuracy of checking components of a device.

Furthermore, the method of matching segmented words to check components in a device of the present invention can be implemented by hardware, software or a combination thereof, and can be implemented in a computer system by a centralization manner, or by a distribution manner of different components distributed in several interconnect computer systems.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method of matching segmented words to check correctness of components of a device, comprising:
obtaining a component list of components of a target device, wherein the component list comprises one or more component messages;
obtaining a bill of materials of the target device, wherein the bill of materials records pieces of material data;
performing string processing and string segmenting on one of the component messages and one of the pieces of material data, to generate component key words and the material key words corresponding to the one of the component messages;
comparing the component key words and the material key words corresponding to the one of the component messages, and determining that the one of the component messages matches the bill of materials when a quantity of the component key words and the material key words are matched reaches a quantity threshold; and
determining that a check for the target device is passed when all of the component messages match the bill of materials.

2. The method of claim 1, before the step of performing the string processing and segmenting on the one of the component message and the corresponding one of the pieces of material data, further comprising:
determining whether the quantity of the component messages is the same as the quantity of the material data, and/or determining whether a quantity value contained in the one of the component messages is the same as a quantity value of the corresponding one of the pieces of the material data.

3. The method of claim 1, wherein the string processing comprises at least one of upper-case conversion, specific character removal, specific word removal, replacement with abbreviation, replacement with word of same meaning, and conversion of numerical unit.

4. The method of claim 1, the step of determining whether the one of the component messages matches the bill of materials comprises:
defining weights of the component key words; and
when a sum of the weights of the matched component key words reaches a weight threshold, determining that the component message corresponding to the matched component key words matches the bill of materials.

5. The method of claim 1, wherein the step of comparing the component key words and the material key words corresponding to the one of the component messages, comprises:
selecting a comparison manner based on a data type or both of the data type and a string length of each of the component key words, the comparison manner comprises at least one of determining whether the component key word is the same as the material key word, determining whether an edit distance between the component key word and the material key word is lower than a distance threshold, determining whether the component key word is contained in the material key words, determining whether the material key word is contained in the component key words, and determining the material key words corresponding to the component key words based on a long short term memory (LSTM) model.

6. A system of matching segmented words to check correctness of components of a device, comprising:
a message obtaining module, configured to obtain a component list of components of a target device, wherein the component list comprises one or more component messages;
a bill obtaining module, configured to obtain a bill of materials of the target device, wherein the bill of materials records pieces of material data;
a word processing module, configured to perform string processing and string segmenting on one of the component messages and one of the pieces of the material data to generate component key words and the material key words corresponding to the one of the component messages;
a word comparing module, configured to compare the component key words and the material key words corresponding to the one of the component message, and determines that the one of the component messages matches the bill of materials when a quantity of the component key words and the material key words are matched reaches a quantity threshold; and
a result determining module, configured to determine that a check for the target device is passed when all of the component messages match the bill of materials.

7. The system of claim 6, wherein the result determining module is configured to determine whether a quantity of the component messages is the same as a quantity of the pieces of material data, and/or determine whether a quantity value contained in each of the component message is the same as a quantity value contained in the corresponding one of the pieces of the material data.

8. The system of claim 6, wherein the word processing module performs at least one of upper-case conversion, specific character removal, specific word removal, replacement with abbreviation, replacement with words of same meaning, and conversion of numerical unit for string processing.

9. The system of claim 6, wherein the word comparing module is configured to define weights of the component key words, and determines that the component message corresponding to the component key words match the bill of materials when a sum of the weights of the matched component key words reaches a weight threshold.

10. The system of claim 6, wherein the word comparing module selects a comparison manner for comparing the component key words and material key words corresponding to the one of the component messages based on a data type or both of the data type and a string length of each of the component key words, the comparison manner comprises at least one of determining whether the component key word is the same as the material key word, determining whether an edit distance between the component key word and the material key word is lower than a distance threshold, determining whether the component key word is contained in the material key words, determining whether the material key word is contained in the component key words, and determining the material key words corresponding to the component key words based on a LSTM model.
